(19) United States
(12) Patent Application Publication
(10) Pub. No.: US 2024/0179545 A1
(43) Pub. Date: May 30, 2024

(54) Configuring a Motion Sensing System for Operation in an Environment

(71) Applicant: Cognitive Systems Corp., Waterloo (CA)

(72) Inventors: Tajinder Manku, Waterloo (CA); Oleksiy Kravets, Petersburg (CA); William Suriaputra, Waterloo (CA)

(73) Assignee: Cognitive Systems Corp., Waterloo (CA)

(21) Appl. No.: 18/060,137

(22) Filed: Nov. 30, 2022

(51) Int. Cl. H04W 24/08; H04W 4/38

(52) U.S. Cl. CPC H04W 24/08; H04W 4/38

(57) ABSTRACT

In a general aspect, a motion sensing system is configured for operation in an environment. In some aspects, device information for a plurality of wireless communication devices available for use in the motion sensing system is obtained. The motion sensing system data are sent from the motion sensing system to a cloud-based computer system. The motion sensing system data includes the device information and environment information. In response to the motion sensing system data, health score data for the plurality of wireless communication devices are received from the cloud-based computer system. Health scores for the plurality of wireless communication devices are configured according to the health score data. Based on the health scores, a subset of the plurality of wireless communication devices are selected for motion detection. The motion sensing system is updated to use the selected subset of wireless communication devices for motion detection.

### BACKGROUND

The following description relates to configuring a motion sensing system for operation in an environment.

Motion sensing systems have been used to detect movement, for example, of objects in a room or an outdoor area. In some example motion sensing systems, infrared or optical sensors are used to detect movement of objects in the sensor's field of view. Motion sensing systems have been used in security systems, automated control systems, and other types of systems.

### DESCRIPTION OF DRAWINGS

FIG. 1 is a block diagram showing an example wireless communication system.

FIG. 2 includes block diagrams showing aspects of an example motion sensing system.

FIGS. 3A-3B are block diagrams showing aspects of an example computing environment and an example motion sensing system.

FIG. 4 is a block diagram showing an example wireless communication device.

FIG. 5A is a ladder diagram showing aspects of an example process.

FIG. 5B is a flow chart showing aspects of an example process for determining health score data of wireless communication devices in a motion sensing system.

FIG. 5C is a flow chart showing aspects of an example process for determining controlling, modifying, or reconfiguring a motion sensing topology of a motion sensing system.

FIGS. 6A-6B are tables showing aspects of an example database stored in a cloud-based computer system.

### DETAILED DESCRIPTION

In some aspects of what is described here, a wireless motion sensing system is configured based on data from a cloud-based computer system. The cloud-based computer system can collect data and derive intelligence from a network of many motion sensing systems, and the intelligence can be used to configure or re-configure individual motion sensing systems. For example, the cloud-based computer system can amass information from thousands or millions of devices in a vast network of motion sensing systems. With all the information from the various device across the network, health scores and other types of knowledge can be extracted and used to improve the operation of the motion sensing systems. For instance, it may be possible to fingerprint devices based on a portion of their mac address (such as through an API provided by Fing). In some implementations, the cloud-based computer system can develop metrics for various devices, device types, chipsets, etc., as well as configuration settings for initializing environments (e.g., two story house vs. bungalow vs. apartment). Such metrics and configuration settings can provide suggestions for prioritizing devices, initial conditions for a new system setup, or operating conditions from which to learn optimal or improved conditions.

In some implementation, a cloud-based computer system can provide health scores for devices in a motion sensing system, and the health scores can be used to improve operation of the motion sensing system. For example, the health scores may inform how frequently to ping particular devices, the signal strength used to ping devices, the requested power used for the response, and other parameters. In some cases, health score data can be provided to device manufacturers to help them improve their devices for wireless motion sensing. In some cases, the health score data can be combined with other data sources to see, e.g., how local environmental conditions affect readings, both in-house type conditions (building materials, location, internal temp, style of house, etc.) and broader external environmental factors (external temperature, humidity, time of day, etc.). Also, certain decisions can be made by the cloud-based computer system, which may save CPU processing power on the motion sensing system, and may improve overall motion sensing performance. In some cases, the health score data can be used to bias the selection of devices to be used for wireless motion detection. In some cases, the selection can be dynamic; for example, the motion sensing system may choose a higher or lower number of devices based on the environment. In some cases, the health score data can be used to certify certain devices to be used for wireless motion detection.

In some cases, a cloud-based computer system stores a variety of data for a number of wireless communication devices. For instance, the cloud-based computer system may store data such as: Client name (e.g., a certain brand or model smart device), health score, signal power, pinging score, size of house, type of house, Wi-Fi chip set, device type, history of past sounding/pinging performance (prior health scores), RF capabilities (2 GHz, 5 GHz, bw capabilities, Wi-Fi capabilities, etc.), etc. This data maybe compiled into groups; for example, the average motion score and standard deviation for all smart devices of a certain brand or model. This information can then be used to generate an overall health score that indicates how well the brand or model of device operates as a wireless motion sensor.

In some implementations, a motion sensing system can be used for wireless sensing applications by processing wireless signals (e.g., radio frequency signals) transmitted through a space between wireless communication devices. Example wireless sensing applications include motion detection, which can include one or more of the following: detecting motion of objects in the space, motion tracking, motion localization, breathing detection, breathing monitoring, presence detection, gesture detection, gesture recognition, human detection (e.g., moving and stationary human detection), human tracking, fall detection, speed estimation, intrusion detection, walking detection, step counting, respiration rate detection, apnea estimation, posture change detection, activity recognition, gait rate classification, gesture decoding, sign language recognition, hand tracking, heart rate estimation, breathing rate estimation, room occupancy detection, human dynamics monitoring, and other types of motion detection applications. Other examples of wireless sensing applications include object recognition, speaking recognition, keystroke detection and recognition, tamper detection, touch detection, attack detection, user authentication, driver fatigue detection, traffic monitoring, smoking detection, school violence detection, human counting, metal detection, human recognition, bike localization, human queue estimation, Wi-Fi imaging, and other types of wireless sensing applications. For instance, the motion sensing system may operate as a motion sensing system to detect the existence and location of motion based on Wi-Fi signals or other types of wireless signals.

The examples described above may be useful for home monitoring. Home monitoring using the motion sensing systems described herein provides several advantages, including full home coverage through walls and darkness, discreet detection without cameras, higher accuracy and reduced false alerts (e.g., in comparison with sensors that do not use Wi-Fi signals to sense their environments), and adjustable sensitivity. By layering Wi-Fi motion detection capabilities into routers and gateways, a robust motion sensing system may be provided.

The examples described above may also be useful in wellness monitoring. Caregivers want to know their loved ones are safe, while seniors and people with special needs want to maintain their independence at home with dignity. Wellness monitoring using the motion sensing systems described herein provides a solution that uses wireless signals to detect motion without using cameras or infringing on privacy, generate alerts when unusual activity is detected, track sleep patterns, and generate preventative health data. For example, caregivers can monitor motion, visits from health care professionals, and unusual behavior such as staying in bed longer than normal. Furthermore, motion is monitored unobtrusively without the need for wearable devices, and the motion sensing systems described herein can offer a more affordable and convenient alternative to assisted living facilities and other security and health monitoring tools.

The examples described above may also be useful in setting up a smart home. In some examples, the motion sensing systems described herein use predictive analytics and artificial intelligence (AI), to learn movement patterns and trigger smart home functions accordingly. Examples of smart home functions that may be triggered include adjusting the thermostat when a person walks through the front door, turning other smart devices on or off based on preferences, automatically adjusting lighting, adjusting HVAC systems based on present occupants, etc.

In some aspects of what is described here, wireless signals transmitted on wireless communication links are analyzed to determine channel state information, which can be used for wireless sensing. The channel state information may be representative of a physical medium that applies a transfer function to wireless signals that traverse a space. In some instances, the channel state information includes a channel response. Channel responses can characterize a physical communication path, representing the combined effect of, for example, scattering, fading, and power decay within the space between the transmitter and receiver. In some instances, the channel state information includes beamforming state information (e.g., a feedback matrix, a steering matrix, channel state information (CSI), etc.) provided by a beamforming system. Beamforming is a signal processing technique often used in multi antenna (multiple-input/multiple-output (MIMO)) radio systems for directional signal transmission or reception. Beamforming can be achieved by operating elements in an antenna array in such a way that signals at particular angles experience constructive interference, while others experience destructive interference. The channel state information of a wireless communication link may be analyzed (e.g., by an access point or other device in a wireless communication network, or a remote device that receives information from the network) to detect, for example, whether motion has occurred in the space, to determine a relative location of the detected motion, or both. In some aspects, the channel state information for each of the wireless communication links may be analyzed to detect whether an object is present or absent, e.g., when no motion is detected in the space.

Example motion detection and localization algorithms that can be used to detect motion based on wireless signals include the techniques described in U.S. Pat. No. 9,523,760 entitled “Detecting Motion Based on Repeated Wireless Transmissions,” U.S. Pat. No. 9,584,974 entitled “Detecting Motion Based on Reference Signal Transmissions,” U.S. Pat. No. 10,051,414 entitled “Detecting Motion Based On Decompositions Of Channel Response Variations,” U.S. Pat. No. 10,048,350 entitled “Motion Detection Based on Groupings of Statistical Parameters of Wireless Signals,” U.S. Pat. No. 10,108,903 entitled “Motion Detection Based on Machine Learning of Wireless Signal Properties,” U.S. Pat. No. 10,109,167 entitled “Motion Localization in a Wireless Mesh Network Based on Motion Indicator Values,” U.S. Pat. No. 10,109,168 entitled “Motion Localization Based on Channel Response Characteristics,” U.S. Pat. No. 10,743,143 entitled “Determining a Motion Zone for a Location of Motion Detected by Wireless Signals,” U.S. Pat. No. 10,605,908 entitled “Motion Detection Based on Beamforming Dynamic Information from Wireless Standard Client Devices,” U.S. Pat. No. 10,605,907 entitled “Motion Detection by a Central Controller Using Beamforming Dynamic Information,” U.S. Pat. No. 10,600,314 entitled “Modifying Sensitivity Settings in a Motion sensing system,” U.S. Pat. No. 10,567,914 entitled “Initializing Probability Vectors for Determining a Location of Motion Detected from Wireless Signals,” U.S. Pat. No. 10,565,860 entitled “Offline Tuning System for Detecting New Motion Zones in a Motion Sensing System,” U.S. Pat. No. 10,506,384 entitled “Determining a Location of Motion Detected from Wireless Signals Based on Prior Probability,” U.S. Pat. No. 10,499,364 entitled “Identifying Static Leaf Nodes in a Motion sensing system,” U.S. Pat. No. 10,498,467 entitled “Classifying Static Leaf Nodes in a Motion sensing system,” U.S. Pat. No. 10,460,581 entitled “Determining a Confidence for a Motion Zone Identified as a Location of Motion for Motion Detected by Wireless Signals,” U.S. Pat. No. 10,459,076 entitled “Motion Detection based on Beamforming Dynamic Information,” U.S. Pat. No. 10,459,074 entitled “Determining a Location of Motion Detected from Wireless Signals Based on Wireless Link Counting,” U.S. Pat. No. 10,438,468 entitled “Motion Localization in a Wireless Mesh Network Based on Motion Indicator Values,” U.S. Pat. No. 10,404,387 entitled “Determining Motion Zones in a Space Traversed by Wireless Signals,” U.S. Pat. No. 10,393,866 entitled “Detecting Presence Based on Wireless Signal Analysis,” U.S. Pat. No. 10,380,856 entitled “Motion Localization Based on Channel Response Characteristics,” U.S. Pat. No. 10,318,890 entitled “Training Data for a Motion sensing system using Data from a Sensor Device,” U.S. Pat. No. 10,264,405 entitled “Motion Detection in Mesh Networks,” U.S. Pat. No. 10,228,439 entitled “Motion Detection Based on Filtered Statistical Parameters of Wireless Signals,” U.S. Pat. No. 10,129,853 entitled “Operating a Motion Detection Channel in a Wireless Communication Network,” U.S. Pat. No. 10,111,228 entitled “Selecting Wireless Communication Channels Based on Signal Quality Metrics,” and other techniques.

In some instances, aspects of the systems and techniques described here provide technical improvements and advantages over existing approaches. For example, the methods and techniques presented here can facilitate a formation of a motion sensing system by selecting a subset of wireless communication devices from wireless communication devices in a wireless communication network. In some implementations, health score data of wireless communication devices are determined by a cloud-based computer system after receiving device information of the wireless communication devices, environment information where the wireless communication network resides, and other motion sensing system data. The health score data of the wireless communication devices in a wireless communication network can be used to select the subset of wireless communication devices for motion sensing. In some implementations, the methods and techniques can also facilitate the reconfiguration of an existing motion sensing system, for example, when a new wireless communication device is added, an existing wireless communication device is removed, or other modifications that may occur to the wireless communication network. The technical improvements and advantages achieved in examples where the motion sensing system is used for motion detection may also be achieved in examples where the motion sensing system is used for other wireless sensing applications. In some implementations, the methods and techniques presented here can release a computational load on a multi-AP controller or the central AP device for configuring the motion sensing topology of a motion sensing system, and may reduce the time needed for initiating or reconfiguring a motion sensing system. In some implementations, the methods and techniques described here can utilize cloud-based services to facilitate the configuration of a motion sensing system.

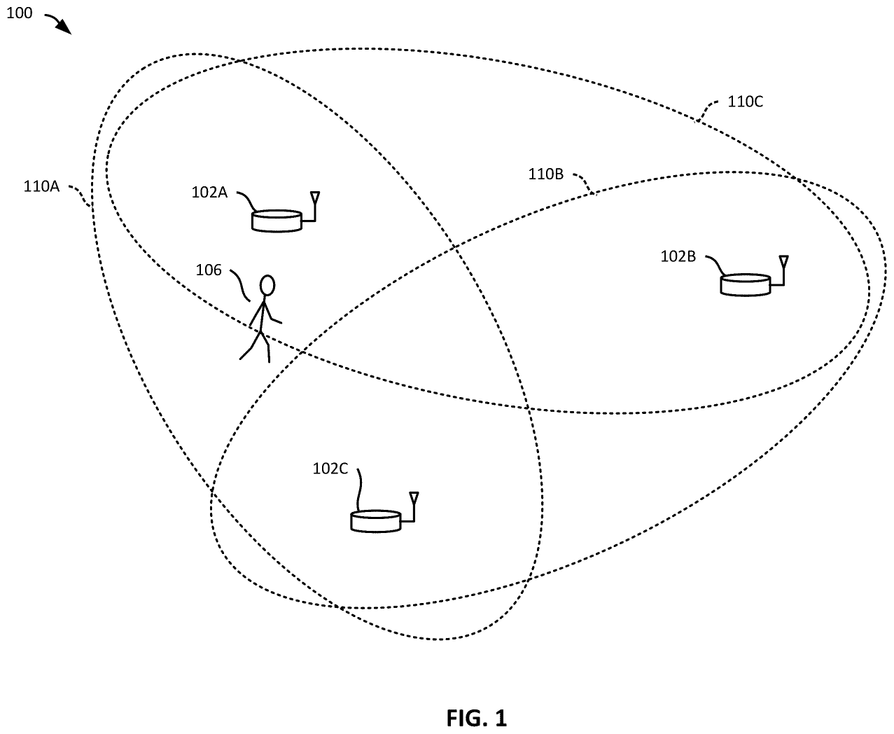

FIG. 1 is a block diagram showing an example wireless communication system 100. The example wireless communication system 100 includes three wireless communication devices 102A, 102B, 102C. The example wireless communication system 100 may include additional wireless communication devices 102 and/or other components (e.g., one or more network servers, network routers, network switches, cables, or other communication links, etc.).

The example wireless communication devices 102A, 102B, 102C operate in a wireless communication network, for example, according to a wireless communication network standard or another type of wireless communication protocol. For example, the wireless communication network may be configured to operate as a Wireless Local Area Network (WLAN), a Personal Area Network (PAN), a metropolitan area network (MAN), or another type of wireless communication network. Examples of WLANs include networks configured to operate according to one or more of the 802.11 family of standards developed by IEEE (e.g., Wi-Fi networks), and others. Examples of PANs include networks that operate according to short-range communication standards (e.g., BLUETOOTH®, Near Field Communication (NFC), ZigBee), millimeter wave communications, and others.

In some implementations, the wireless communication devices 102A, 102B, 102C may be configured to communicate in a cellular network, for example, according to a cellular network standard. Examples of cellular networks include networks configured according to 2G standards such as Global System for Mobile (GSM) and Enhanced Data rates for GSM Evolution (EDGE) or EGPRS; 3G standards such as Code Division Multiple Access (CDMA), Wideband Code Division Multiple Access (WCDMA), Universal Mobile Telecommunications System (UMTS), and Time Division Synchronous Code Division Multiple Access (TD-SCDMA); 4G standards such as Long-Term Evolution (LTE) and LTE-Advanced (LTE-A); 5G standards, and others.

In some cases, one or more of the wireless communication devices 102 is a Wi-Fi access point device or another type of wireless access point (WAP) device. In some cases, one or more of the wireless communication devices 102 is an access point device of a multiple-access point (multi-AP) wireless communication network, such as, for example, a commercially available mesh network system. In some instances, one or more of the wireless communication devices 102 can be implemented as wireless access point (AP) devices in a mesh network, while the other wireless communication device(s) 102 are implemented as client station (STA) devices (e.g., mobile devices, smart devices, etc.) that access the mesh network through one of the AP devices. In some cases, one or more of the wireless communication devices 102 is a mobile device (e.g., a smartphone, a smart watch, a tablet, a laptop computer, etc.), a wireless-enabled device (e.g., a smart thermostat, a Wi-Fi enabled camera, a smart TV), or another type of device that communicates in a wireless communication network.

In the example shown in FIG. 1, the wireless communication devices 102 transmit wireless signals to each other over wireless communication links (e.g., according to a wireless communication network standard or a non-standard wireless communication protocol), and the wireless signals communicated between the wireless communication devices can be used as motion probe signals to detect motion of objects in the signal paths between the wireless communication devices. In some implementations, standard signals (e.g., channel sounding signals, beacon signals, or other standard signals), non-standard reference signals, or other types of wireless signals can be used as motion probe signals. In some implementations, the wireless communication system 100 is configured for motion sensing. In this case, the wireless communication devices 102 of the wireless communication system 100 form a motion sensing system; and the wireless communication links and the wireless communication devices in the wireless communication network determine a motion sensing topology of the motion sensing system. In some implementations, a subset of wireless communication devices and associated wireless communication links may form a motion sensing system, which has a motion sensing topology determined by the subset of wireless communication devices and the associated wireless communication links.

In the example shown in FIG. 1, the wireless communication link between the wireless communication devices 102A, 102C can be used to probe a first motion detection zone 110A, the wireless communication link between the wireless communication devices 102B, 102C can be used to probe a second motion detection zone 110B, and the wireless communication link between the wireless communication device 102A, 102B can be used to probe a third motion detection zone 110C. In some instances, the motion detection zones 110 can include, for example, air, solid materials, liquids, or other mediums through which wireless electromagnetic signals may propagate.

In the example shown in FIG. 1, when an object moves in any of the motion detection zones 110, the motion sensing system may detect the motion based on wireless signals transmitted through the relevant motion detection zone 110. Generally, the object can be any type of static or moveable object, and can be living or inanimate. For example, the object can be a human (e.g., the person 106 shown in FIG. 1), an animal, an inorganic object, or another device, apparatus, or assembly, an object that defines all or part of the boundary of a space (e.g., a wall, door, window, etc.), or another type of object.

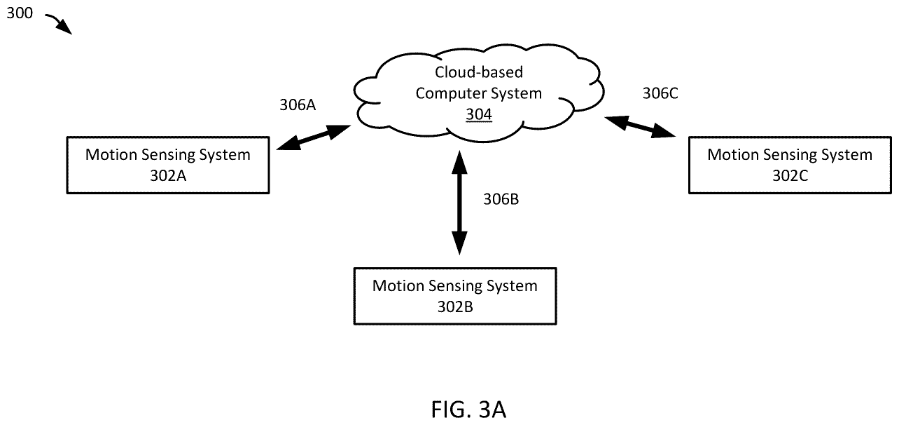

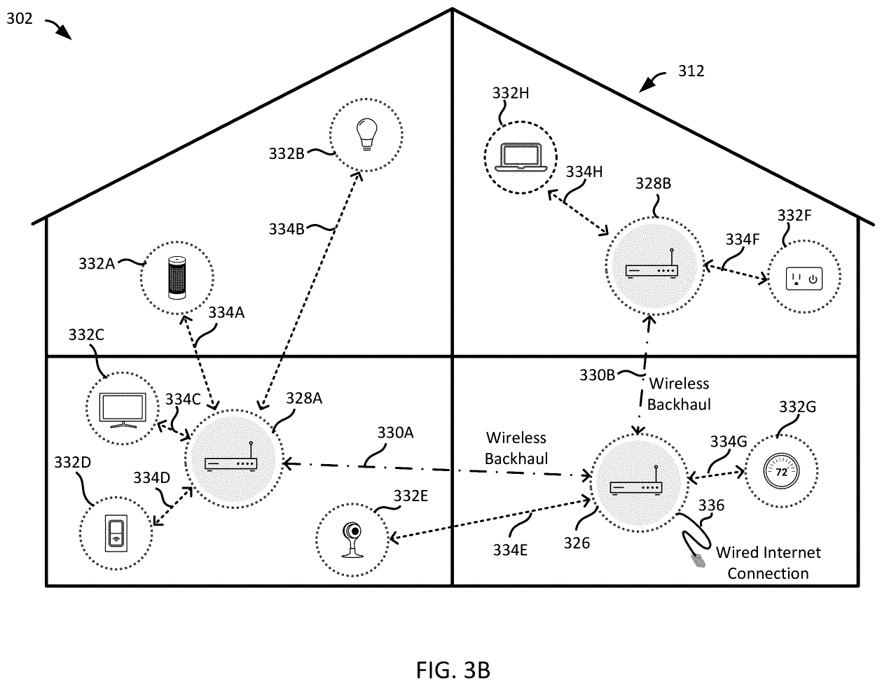

In some examples, the wireless signals may propagate through a structure (e.g., a wall) before or after interacting with a moving object, which may allow the moving object's movement to be detected without an optical line-of-sight between the moving object and the transmitting or receiving wireless communication devices 102. In some implementations, the motion sensing system may communicate motion data to another device or system, such as a security system, a control center, or a cloud computer system (e.g., the cloud-based computer system 304 of FIG. 3A), for cloud-based services, such as data storage and data processing.

In some implementations, the wireless communication devices 102 are configured to perform one or more operations of the motion sensing system, for example, by executing computer-readable instructions (e.g., software or firmware) on the wireless communication devices 102. For example, each wireless communication device 102 may process received wireless signals to detect motion based on changes in the channel state information. In an example aspect of operation, the wireless communication devices 102A, 102B may broadcast wireless signals or address wireless signals to the other wireless communication device 102C, and the wireless communication device 102C (and potentially other devices) receives the wireless signals transmitted by the wireless communication devices 102A, 102B. The wireless communication device 102C (or another system or device) then processes the received wireless signals to detect motion of an object in a space accessed by the wireless signals (e.g., in the zones 110A, 11B). In some instances, the wireless communication device 102C (or another system or device) may perform one or more operations of the motion sensing system. In some cases, another device (e.g., a remote server, a cloud computer system, a network-attached device, etc.) is configured to perform one or more operations of the motion sensing system. For example, one of the wireless communication devices 102 (e.g., a central AP device that connects to a wired LAN) may receive channel state information from associated wireless communication devices 102 and send the channel state information to a specified device, system, or service that process the received channel state information to detect motion.

In some cases, one of the wireless communication devices 102 (e.g., a central access point device that connects to a wired LAN) may collect device information from the wireless communication devices 102 within the motion sensing system and transmit the motion sensing system data to a cloud-based computer system to determine a configuration (e.g., a motion sensing topology) of the motion sensing system. For example, the cloud-based computer system may determine, based on the motion sensing system data and other information, health score data for respective wireless communication devices. In some cases, the health score data for wireless communication devices of the wireless communication network is transmitted back to the wireless communication system 100 and used to determine which wireless communication devices may be used for motion sensing. The motion sensing topology of the motion sensing system can be selected or updated.

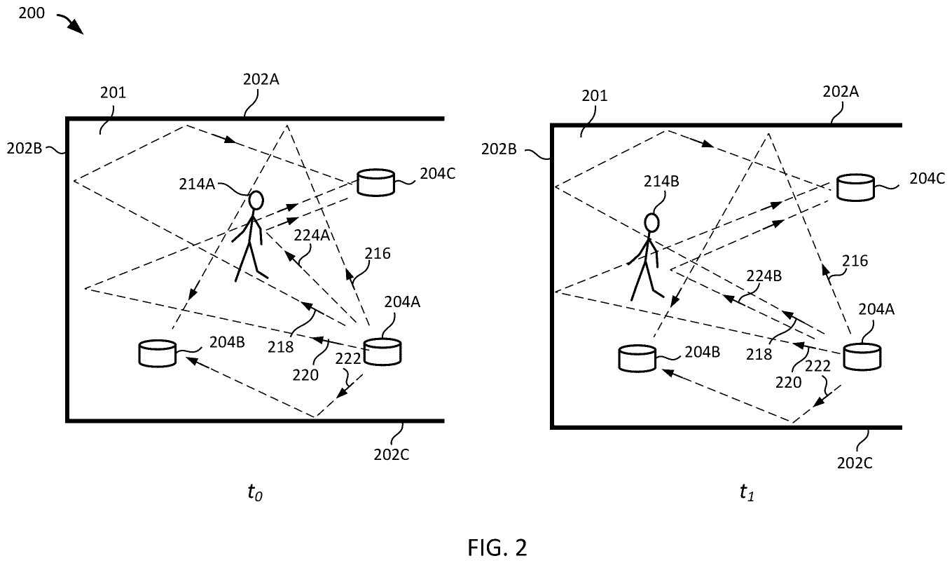

FIG. 2 includes block diagrams showing aspects of an example motion sensing system 200. As shown in FIG. 2, the motion sensing system 200 is deployed to detect motion of an object in a space 201 based on wireless signals communicated between wireless communication devices 204A, 204B, 204C. In some implementations, the wireless communication devices 204A, 204B, 204C may be, for example, the wireless communication devices 102A, 102B, 102C shown in FIG. 1, or may be other types of wireless communication devices. The space 201 may be completely or partially enclosed or open at one or more boundaries of the space 201. In some instances, the space 201 may be, or may include, an interior of a room, multiple rooms, a building, an indoor area, an outdoor area, or other types of spaces. As shown in FIG. 2, a first wall 202A, a second wall 202B, and a third wall 202C at least partially enclose the space 201.

In some cases, a combination of one or more of the wireless communication devices 204A, 204B, 204C can be part of, or may be used in a wireless communication system in the space 201. For example, the wireless communication devices 204A, 204B, 204C can form a wireless communication network and transmit wireless signals for wireless communication purposes through the space 201, operating under a wireless communication standard. The wireless communication topology of a wireless communication system may include a set of wireless communication links or channels between the wireless communication devices 204A, 204B, 204C. The wireless communication topology can be used as a motion sensing topology of the motion sensing system 200 for motion sensing purposes through the space 201. In some implementations, the motion sensing topology may include a subset of the wireless communication devices 204A, 204B, 204C or a subset of the wireless communication links or channels between the wireless communication devices 204A, 204B, 204C.

In the example shown in FIG. 2, the first wireless communication device 204A transmits wireless signals repeatedly (e.g., periodically, intermittently, at scheduled, unscheduled, or random intervals, etc.). The second and third wireless communication devices 204B, 204C receive the wireless signals transmitted by the wireless communication device 204A.

As shown, an object is in a first position 214A at an initial time step (t₀) and the object has moved to a second position 214B at a subsequent time step (t₁). In FIG. 2, the moving object in the space 201 is represented as a human or implemented as the object 106 in FIG. 1. In the example shown in FIG. 2, the wireless communication devices 204A, 204B, 204C are stationary and are, consequently, at the same position at the initial time step t₀ and at the subsequent time step t₁. However, in other examples, one or more of the wireless communication devices 204A, 204B, 204C may move between the initial time step t₀ and the subsequent time step t₁.

As shown in FIG. 2, signal paths of the wireless signals transmitted from the first wireless communication device 204A are illustrated by dashed lines. Along a first signal path 216, the wireless signal is transmitted from the first wireless communication device 204A and reflected off the first wall 202A toward the second wireless communication device 204B. Along a second signal path 218, the wireless signal is transmitted from the first wireless communication device 204A and reflected off the second wall 202B and the first wall 202A toward the third wireless communication device 204C. Along a third signal path 220, the wireless signal is transmitted from the first wireless communication device 204A and reflected off the second wall 202B toward the third wireless communication device 204C. Along a fourth signal path 222, the wireless signal is transmitted from the first wireless communication device 204A and reflected off the third wall 202C toward the second wireless communication device 204B.

At the initial time step to, along a fifth signal path 224A, the wireless signal is transmitted from the first wireless communication device 204A and reflected off the object at the first position 214A toward the third wireless communication device 204C. Between the initial time step t₀ and the subsequent time step t₁, the object moves from the first position 214A to a second position 214B in the space 201 (e.g., some distance away from the first position 214A). At the subsequent time step t₁, along a sixth signal path 224B, the wireless signal is transmitted from the first wireless communication device 204A and reflected off the object at the second position 214B toward the third wireless communication device 204C. The sixth signal path 224B at the subsequent time step t₁ is longer than the fifth signal path 224A at the initial time step t₀ due to the movement of the object from the first position 214A to the second position 214B. In some examples, a signal path can be added, removed, or otherwise modified due to movement of the object or another object in the space 201.

In some implementations, the wireless signals communicated in the motion sensing system 200 shown in FIG. 2, when propagating through their respective signal paths, experience attenuation, frequency shifts, interference, phase shifts, or other effects and may have portions that propagate in another direction, for example, through the walls 202A, 202B, and 202C. In some examples, the wireless signals are radio frequency (RF) signals or other types of signals.

In some implementations, the wireless signals communicated in the motion sensing system 200 shown in FIG. 2 may have a number of frequency components in a frequency bandwidth, or may include one or more bands within the frequency bandwidth. The wireless signals communicated in the motion sensing system 200 shown in FIG. 2 may be transmitted from a wireless communication device 204 in an omnidirectional manner, in a directional manner, or otherwise. In the example shown, the wireless signal transmitted by the first wireless communication device 204A traverses multiple respective signal paths in the space 201. In some cases, the wireless signal along a signal path may become attenuated due to path losses, scattering, reflection, absorption, or the like and may have a phase or frequency offset.

As shown in FIG. 2, the wireless signals along the signal paths 216, 218, 220, 222, 224A, and 224B combine at the third wireless communication device 204C and the second wireless communication device 204B to form received signals. Because of the effects of the multiple signal paths in the space 201 on the wireless signal, the space 201 can be represented as a filter with a transfer function in which the wireless signals are the input and the received signals are output. When an object moves in the space 201, the attenuation or phase offset applied to a wireless signal along a signal path can change, and hence, the transfer function (e.g., the channel response) of the space 201 can change. When the same wireless signal is transmitted from the first wireless communication device 204A, if the transfer function of the space 200 changes, the output of that transfer function, e.g., the received signal, can also change. A change in the received signal can be used to detect movement of an object. Conversely, in some cases, if the transfer function of the space does not change, the output of the transfer function—the received signal—may not change.

Mathematically, a wireless signal f(t) transmitted from a wireless communication device (e.g., the first wireless communication device 204A) may be described according to Equation (1):

$$f ( t ) = {\sum }_{n = - ∞}^{∞} {c}_{n} {e}^{j {ω}_{n} t} \qquad ( 1 )$$

where ωₙ represents the frequency of n^{th} frequency component of the wireless signal, cₙ represents the complex coefficient of the n^{th} frequency component, and t represents time. With the wireless signal f(t) being transmitted from the first wireless communication device 204A, an output signal rₖ(t) from a path k may be described according to Equation (2)

$${r}_{k} ( t ) = {\sum }_{n = - ∞}^{∞} {α}_{n , k} {c}_{n} {e}^{j ( {ω}_{n} t + {ϕ}_{n , k} )} \qquad ( 2 )$$

where α_{n,k} represents an attenuation factor (or channel response; e.g., due to scattering, reflection, and path losses) for the n^{th} frequency component along signal path k, and ϕ_{n,k} represents the phase of the wireless signal for n^{th} frequency component along signal path k. Then, the received signal R at another wireless communication device (e.g., the second wireless communication device 204B or the third wireless communication device 204C) can be described as the summation of all output signals rₖ(t) from all signal paths to the wireless communication device, which is shown in Equation (3):

$$R = {\sum }_{k} {r}_{k} ( t ) \qquad ( 3 )$$

Substituting Equation (2) into Equation (3) renders the following Equation (4):

$$R = {\sum }_{k} {\sum }_{n = - ∞}^{∞} ( {α}_{n , k} {e}^{j {ϕ}_{n , k}} ) {c}_{n} {e}^{j {ω}_{n} t} \qquad ( 4 )$$

The received signal R at a wireless communication device can then be analyzed, for example, to detect motion. The received signal R at a wireless communication device can be transformed to the frequency domain, for example, using a Fast Fourier Transform (FFT) or another type of algorithm. The transformed signal can represent the received signal R as a series of n complex values, one for each of the respective frequency components (at the n frequencies ωₙ). For an n-th frequency component at a frequency ωₙ, a complex value Yₙ may be represented as follows in Equation (5):

$${Y}_{n} = {\sum }_{k} {c}_{n} {α}_{n , k} {e}^{j {ϕ}_{n , k}} \qquad ( 5 )$$

where the complex value Yₙ for the n-th frequency component at the frequency ωₙ indicates a relative magnitude and phase offset of the received signal at the n-th frequency component. When an object moves in the space, the complex value Yₙ changes due to the change in the channel response α_{n,k} of the space. Accordingly, a change detected in the channel response (and thus, the complex value Yₙ) can be indicative of movement of an object within the communication channel. Conversely, a stable channel response α_{n,k} may indicate lack of motion. Thus, in some implementations, the complex values Yₙ for each of the wireless communication devices 204 in the motion sensing system 200 can be processed to detect whether motion has occurred in the space 201 traversed by the transmitted signals f(t).

In another aspect of FIG. 2, beamforming may be performed between the wireless communication devices 204 based on some knowledge of the wireless communication link or channel (e.g., through feedback properties generated by a receiver device), which can be used to generate one or more steering properties (e.g., a steering matrix) that are applied by a transmitter device to shape the transmitted beam/signal in a particular direction or directions. In some instances, changes to the steering or feedback properties used in the beamforming process indicate changes, which may be caused by moving objects in the space traversed by the wireless signals. For example, motion may be detected by identifying substantial changes in the wireless communication channel, e.g. as indicated by a channel response, or steering or feedback properties, or any combination thereof, over a period of time.

In some implementations, a steering matrix may be generated at a transmitter device (e.g., a beamformer) based on a feedback matrix provided by a receiver device (e.g., beamformee) based on channel sounding. Because the steering and feedback matrices are related to propagation characteristics of the wireless communication channel, these matrices change as objects move within the wireless communication channel. Changes in the channel characteristics are accordingly reflected in these matrices, and by analyzing the matrices, motion can be detected, and different characteristics of the detected motion (e.g., direction, type, speed, magnitude, etc.) can be determined. In some implementations, a spatial map is generated based on one or more beamforming matrices. The spatial map may indicate a general direction of an object in a space relative to a wireless communication device. In some cases, “modes” of a beamforming matrix (e.g., a feedback matrix or steering matrix) can be used to generate the spatial map. In some instances, a spatial map can be used to detect the presence of motion in the space, to detect a location of the detected motion, to indicate characteristics of the detected motion.

FIGS. 3A-3B are block diagrams showing aspects of an example system 300 and an example motion sensing system 302. As shown in FIG. 3A, the example system 300 includes multiple motion sensing systems 302 and a cloud-based computer system 304. In some implementations, the cloud-based computer system 304 includes computing resources (e.g., software and hardware) configured to perform computing tasks, to store data, or to perform other functions. As shown in FIG. 3A, the example system 300 includes multiple motion sensing systems 302 that communicate with the cloud-based computer system 304 via data connections 306 (e.g., over the Internet). While three motion sensing systems are shown in FIG. 3A, the system 300 may generally include many hundreds or thousands of motion sensing systems.

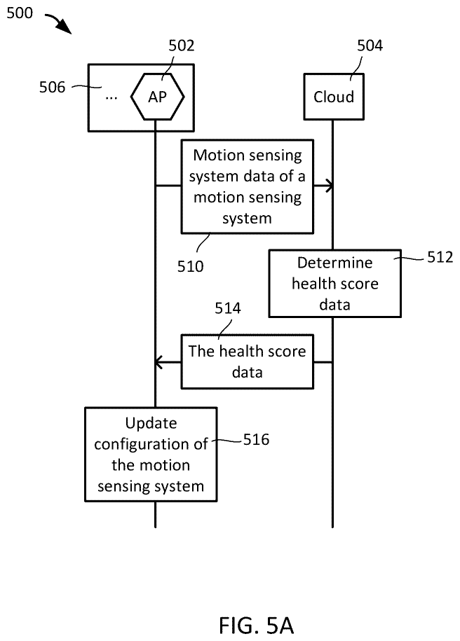

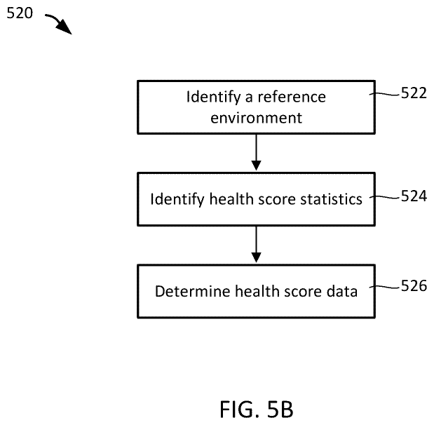

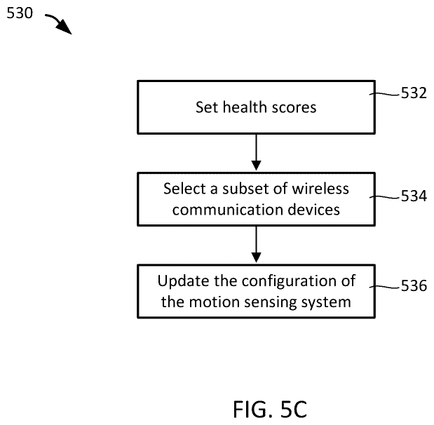

In the example shown in FIG. 3A, the motion sensing systems 302 operate in different locations, which may generally be geographically remote from each other and may have distinct properties. In some instances, each of the motion sensing systems 302 shown in FIG. 3A may operate as the example motion sensing system 200 in FIG. 2, the example motion sensing system 302 in FIG. 3B, or in another manner. The system 300 may include additional or different features, and the components of the system 300 may operate as described with respect to FIG. 3A or in another manner. In some implementations, the motion sensing system 302 and the cloud-based computer system 304 may perform one or more operations of the example processes 500, 520, 530 shown in FIGS. 5A-5C.

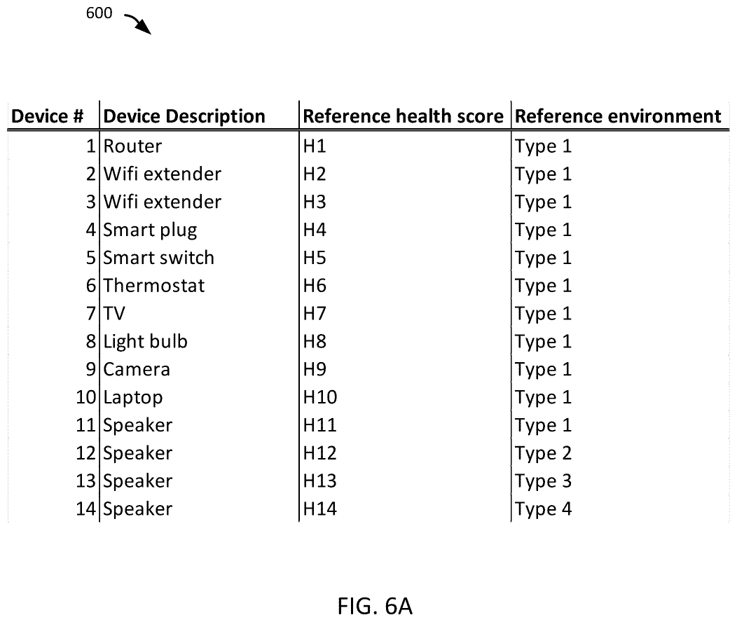

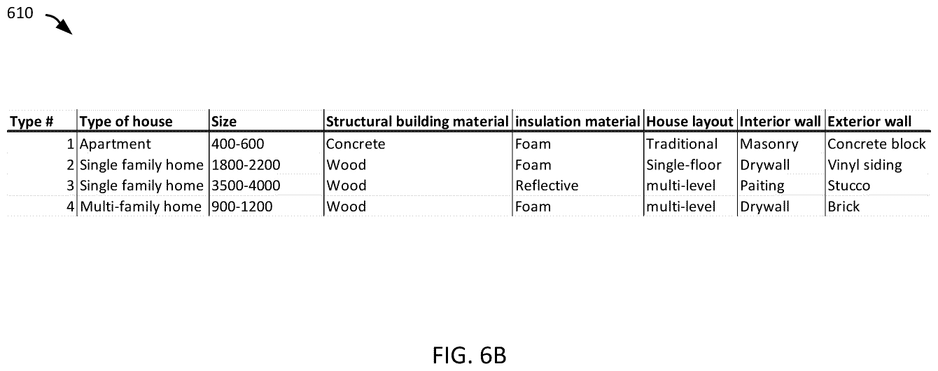

In some implementations, the cloud-based computer system 304 includes a reference database (e.g., the example database 600, 610 shown in FIGS. 6A-6B) which stores reference health scores of various wireless communication devices in various reference environments. In some implementations, a reference health score characterizes motion sensing performance of a wireless communication device in a reference environment. Motion sensing system data can be prepared by the motion sensing system 302 (e.g., the central AP device 326 of the motion sensing system 302 shown in FIG. 3B) and transmitted to the cloud-based computer system 304 via the connections 306. In some implementations, the motion sensing system data includes device information of wireless communication devices, environment information for an environment where the motion sensing system resides, and other motion sensing system data. When the motion sensing system data are received by the cloud-based computer system 304 from the motion sensing system 302, the cloud-based computer system 304 refers to the reference database and determines the health score data for the wireless communication devices of the motion sensing system 302. In some examples, the cloud-based computer system 304 may further include programs or algorithms that can determine the health score data based on the same wireless communication device in similar environments, different wireless communication devices in the same environment, or in another manner. In this case, the health score data are determined based on health score statistics from the reference database (e.g., an average reference health score and a standard deviation). The health score data of the wireless communication devices of the motion sensing system 302 can be transmitted back to the motion sensing system 302 and used to guide the configuration of the motion sensing topology of the motion sensing system 302. For example, health score data of wireless communication devices of a motion sensing system 302 can be used by the motion sensing system 302 to determine performance of the wireless communication devices in a particular environment, to modify a motion sensing topology of the motion sensing system 302 by removing or adding one or more wireless communication devices for motion sensing, removing or adding one or more wireless communication links for motion sensing, selecting a subset of wireless communication devices for motion sensing, or in another manner.

As shown in FIG. 3B, the motion sensing system 302 includes a wireless communication network. In some implementations, the motion sensing system 302 is based on a multi-AP wireless communication network (e.g., a mesh network or a Self-Organizing-Network (SON)) that includes multiple access point (AP) devices (e.g., the AP devices 326, 328A, 328B) and multiple client station (STA) devices (e.g., the STA devices 332A, 332B, 332C, 332D, 332E, 332F, 332G, and 332H). The STA device communicate with associated AP devices on respective wireless communication links (e.g., the wireless communication links 334A, 334B, 334C, 334D, 334E, 334F, 334G, and 334H). The wireless communication devices (e.g., the AP devices and the STA devices) in the example motion sensing system 310 are organized in a wireless communication topology, which can be configured to optimize or otherwise improve wireless communication performance in an example space 312. The multi-AP wireless communication network may operate based on a wireless communication standard, examples being Wi-Fi Direct (which may have STA-to-STA information), the IEEE 802.11md standard, and the IEEE 802.11ax standard.

The example space 312 shown in FIG. 3B is a home that includes multiple distinct spatial regions or zones. In the example shown, the motion sensing system 302 is based on a multi-AP home Wi-Fi network, which includes three AP devices, e.g., a central AP device 326 and two extension AP devices 328A, 328B. In the multi-AP home Wi-Fi network, each AP device can support multiple frequency bands (e.g., 2.4 GHz or 5 GHz), and multiple frequency bands may be enabled at the same time. Each AP device may use a different Wi-Fi channel to serve its associated STA devices, as this may allow for better spectrum efficiency.

In some instances, the central AP device 326 may be or include a multi-AP controller. A multi-AP controller is configured for performing functions, including network and configuration, backhaul topology control, spectrum efficiency management, quality of service (QOS) optimization, network topology control, and other functions. In certain instances, the device that provides multi-AP controller functionality may be selected from the multiple AP devices within the multi-AP home Wi-Fi network according to a predefined criteria. In some instances, the multi-AP controller functionality may be provided by a remote device or system, e.g., by a cloud-based computer system 304. The selection of the central AP device or the multi-AP controller can be managed by manufacturer software running on each AP device. For example, the central AP device can be the AP device that has a wired internet connection 336 and thus has the access to the cloud-based computer system 304 in FIG. 3A.

In the example shown in FIG. 3B, the other AP devices (e.g., the extension AP devices) 328A, 328B connect to the central AP device 326 wirelessly, through respective wireless backhaul connections 330A, 330B. The central AP device 326 may select a wireless communication channel/link different from those with the extension AP devices to serve its associated STA devices. The extension AP devices 328A, 328B connect to the central AP device 326 using the respective wireless backhaul connections 330A, 330B to move network traffic between the AP devices and provide a gateway to the Internet. The extension AP devices 328A, 328B extend the range of the central AP device 326, by allowing STA devices to connect to a potentially closer AP device or different channel, thus yielding the wireless communication topology of the multi-AP home Wi-Fi network shown in FIG. 3B. In some examples, respective STA devices are designated or associated to respective AP devices in the wireless communication topology. Each of the extension AP devices 328A, 328B may select a different wireless communication link to serve its associated STA devices.

In the example shown in FIG. 3B, the STA devices 332A, 332B, 332C, 332D, 332E, 332F, 332G, and 332H connect to either the central AP device 326 or one of the extension AP devices 328A, 328B, using the respective wireless communication links 334A, 334B, 334C, 334D, 334E, 334F, 334G, and 334H as shown in FIG. 3B. The STA devices 332A, 332B, 332C, 332D, 332E, 332F, 332G, 332H may include mobile devices, a smartphone, a smart watch, a tablet, a laptop computer, a smart thermostat, a wireless-enabled camera, a smart TV, a wireless-enabled speaker, a wireless-enabled power socket, a wireless-enabled light bulb, a wireless-enabled switch, or any other types of wireless-enabled devices.

In the example shown in FIG. 3B, the STA devices 332A, 332B, 332C, 332D are associated (e.g., by the respective wireless communication links 334A, 334B, 334C, 334D) with the extension AP device 328A. Similarly, the STA devices 332E and 332G are associated (e.g., by the respective wireless communication links 334E, 334G) with the central AP device 326. In like manner, the STA devices 332F and 332H are associated (e.g., by the wireless communication links 334F, 334H) with the extension AP device 328B. Each of the wireless communication channels (or frequency bands) used for the wireless backhaul connections 330A, 330B may be different than the wireless communication channels (or frequency bands) of the wireless communication links 334 used for serving the associated STA devices.

In the example shown in FIG. 3B, each of the wireless communication links 334A, 334B, 334C, 334D, 334E, 334F, 334G, and 334H makes use of the wireless communication channel or frequency band selected by the respective AP devices that the corresponding devices 332A, 332B, 332C, 332D, 332E, 332F, 332G, and 332H are associated with. Each AP device may select its own wireless communication channel independently to serve the respective STA devices, and the wireless communication links 334 may be used for data communications.

In the example shown in FIG. 3A, the central AP device 326 is connected to the wired Internet connection 336, which extends internet connectivity to the multi-AP home Wi-Fi network. As such, Internet bound traffic from STA devices connected to an AP device (e.g., the extension AP devices 328A, 328B) without a wired Internet connection are carried on a respective wireless backhaul connection (e.g., the wireless backhaul connection 330A or 330B) to an AP device (e.g., the central AP device 326) with a wired Internet connection.

In some implementations, the physical environment of the motion sensing system 302 affects wireless signals propagation between the wireless communication devices, and thus affects motion sensing performance of the motion sensing system 302. For example, wireless signals have different propagation loss as they penetrate different building materials between offices, rooms, or corridors, such as painting, wood, drywall, glass, and concrete. Interference may also be caused by neighboring spaces where other wireless communication systems or motion sensing systems reside. For example, in condos or apartments, wireless signals from neighboring Wi-Fi systems may penetrate through the insulating materials and walls introducing potential interference. For another example, wireless signals may experience more reflection if a wireless communication device is surrounded by large house-hold appliances. In this case, locations of the wireless communication devices, the layout of the space, or functions of sub-divisional areas (e.g., rooms or offices) can affect the motion sensing performance of the wireless communication devices. Propagation loss of wireless signals can also be affected by surface textures of walls, doors, window blinds, etc. Propagation loss of wireless signals can be also affected by different house types, house locations, etc. Therefore, environment information for the environment where the motion sensing system resides is important and can impact motion sensing performance (e.g., accuracy, sensitivity, range, etc.) of wireless communication devices in the motion sensing system 302.

In the example shown in FIGS. 3A-3B, the central AP device 326 in a motion sensing system 302 communicates with the cloud-based computer system 304 in FIG. 3A to provide motion sensing system data and receive cloud-based services. For example, motion sensing system data can be collected by the central AP device 326. In some implementations, motion sensing system data includes device information of the wireless communication devices (e.g., manufacture, model, version, etc.), environment information for the environment where a motion sensing system 302 resides (e.g., size, location, type, etc.), and other information of the motion sensing system 302 (e.g., a type of the wireless communication network, a number of devices, a type of communication standard, etc.).

The examples described above may be configured to operate based on a wireless communication standard, examples being Wi-Fi Direct, the IEEE 802.11md standard, the IEEE 802.11az standard, the IEEE 802.11ax standard, and the IEEE 802.11be standard. In some cases, each of the wireless communication standard may have distinct operating parameters and may enable distinct motion sensing capabilities.

In some implementations, the cloud-based computer system 304 determines health score data for the wireless communication devices of the motion sensing system 302 based on the received motion sensing system data, according to a reference database. The health score data are then transmitted back to the central AP device 326 of the motion sensing system 302 from the cloud-based computer system 304 through the data connection 306. In some implementations, the health score data for the wireless communication devices are evaluated by the central AP device 326 of the motion sensing system 302 and the motion sensing system is configured. For example, the motion sensing topology of the motion sensing system can be updated. In this case, one or more wireless communication devices and one or more associated wireless communication links may be removed from the motion sensing topology due to the low health score data of the one or more wireless communication devices. The one or more wireless communication devices and the one or more associated wireless communication links are, thus, not used for motion sensing under this motion sensing topology. In other words, a subset of wireless communication devices and a subset of wireless communication links are selected for motion sensing.

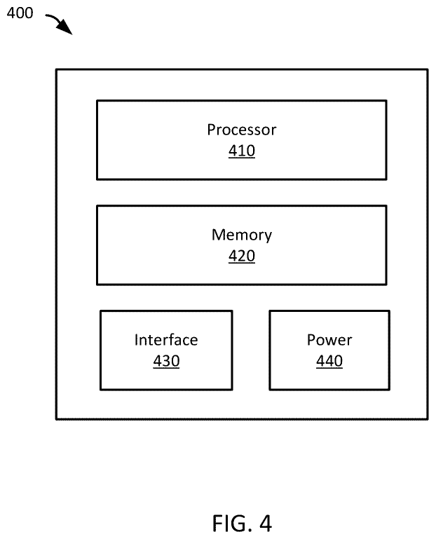

FIG. 4 is a block diagram showing an example wireless communication device 400. The example wireless communication device 400 may be deployed as the STA devices 332 or the AP devices 326, 328 in FIG. 3B. As shown in FIG. 4, the example wireless communication device 400 includes a processor 410, a memory 420, an interface 430, and a power unit 440. A wireless communication device may include multiple of the components shown in FIG. 4 (e.g., multiple processors, multiple memory components, etc.). A wireless communication device may include additional or different components, and the wireless communication device 400 may be configured to operate as described with respect to the examples above or in another manner. In some implementations, the components of the wireless communication device 400 are housed together in a common housing or other assembly. In some implementations, one or more of the components of a wireless communication device can be housed separately, for example, in a separate housing or other assembly.

In some implementations, the interface 430 can communicate (e.g., receive, transmit, or both) wireless signals. For example, the interface 430 may be configured to communicate radio frequency (RF) signals formatted according to a wireless communication standard (e.g., Wi-Fi, 4G, 5G, Bluetooth, etc.). In some implementations, the interface 430 includes a radio subsystem and a baseband subsystem. The radio subsystem may include, for example, one or more antennas and radio frequency circuitry. The radio subsystem can be configured to communicate radio frequency wireless signals on the wireless communication channels. As an example, the radio subsystem may include a radio chip, an RF front end, and one or more antennas. The baseband subsystem may include, for example, digital electronics configured to process digital baseband data. In some cases, the baseband subsystem may include a digital signal processor (DSP) device or another type of processor device. In some cases, the baseband system includes digital processing logic to operate the radio subsystem, to communicate wireless communication network traffic through the radio subsystem or to perform other types of processes.

In some implementations, the processor 410 can execute instructions, for example, to generate output data based on data inputs. The instructions can include programs, codes, scripts, modules, or other types of data stored in the memory 420. Additionally or alternatively, the instructions can be encoded as pre-programmed or re-programmable logic circuits, logic gates, or other types of hardware or firmware components or modules. The processor 410 may be or include a general-purpose microprocessor, as a specialized co-processor or another type of data processing apparatus. In some cases, the processor 410 performs high level operation of the wireless communication device 400. For example, the processor 410 may be configured to execute or interpret software, scripts, programs, functions, executables, or other instructions stored in the memory 420. In some implementations, the processor 410 may be included in the interface 430 or another component of the wireless communication device 400.

In some implementations, the memory 420 may include computer-readable storage media, for example, a volatile memory device, a non-volatile memory device, or both. The memory 420 may include one or more read-only memory devices, random-access memory devices, buffer memory devices, or a combination of these and other types of memory devices. In some instances, one or more components of the memory 420 can be integrated or otherwise associated with another component of the wireless communication device 400. The memory 420 may store instructions that are executable by the processor 410. For example, the instructions may include instructions to perform one or more of the operations 510, 514, 516 of the example process 500 in FIGS. 5A and 5C.

In some implementations, the power unit 440 provides power to the other components of the wireless communication device 400. For example, the other components may operate based on electrical power provided by the power unit 440 through a voltage bus or other connection. In some implementations, the power unit 440 includes a battery or a battery system, for example, a rechargeable battery. In some implementations, the power unit 440 includes an adapter (e.g., an AC adapter) that receives an external power signal (from an external source) and converts the external power signal to an internal power signal conditioned for a component of the wireless communication device 400. The power unit 420 may include other components or operate in another manner.

FIG. 5A is a ladder diagram showing aspects of an example process 500. The example process 500 can be performed between an access point (AP) device 502 of a motion sensing system 506 and a cloud-based computer system 504. For example, the AP device 502 of the motion sensing system 506 and the cloud 504 may be implemented as the central AP device 326 of the example motion sensing system 310 and the cloud-based computer system 304 in the example environment 300 in FIGS. 3A and 3B. In some examples, the motion sensing system 506 includes other wireless communication devices, e.g., extended AP devices and STA devices. Each AP device may include one or more associated STA devices(“leaf” nodes). In some implementations, the wireless communication devices communicate with one another on respective wireless communication links forming a wireless communication network (e.g., the multi-AP home Wi-Fi network of the motion sensing system 302 in FIG. 3B). In some instances, the wireless communication network may include other wireless communication devices. In some implementations, the wireless communication network is a standardized wireless communication network that executes the example process 500 and operates based on a wireless communication standard, examples being Wi-Fi Direct, the IEEE 802.11md standard, and the IEEE 802.11ax standard.

In some implementations, motion detection is performed on the wireless communication links between the associated STA devices and the AP devices. In some implementations, the wireless communication devices and the wireless communication links define a motion sensing topology of the motion sensing system 506. In some implementations, the example process 500 is used to configure or reconfigure the motion sensing system 506 by updating the motion sensing topology of a motion sensing system 506. In certain instances, the example process 500 may be performed when a multi-AP home Wi-Fi network is initialized, when a new wireless communication device is added to an existing multi-AP home Wi-Fi network, or in other circumstances to prioritize wireless communication devices, to facilitate initialization of a new system, to improve motion sensing performance, or for other purposes. The example process 500 as shown in FIG. 5A may include additional or different operations, including operations performed by additional or different components, and the operations may be performed in the order shown or in another order. In some cases, operations in the example process 500 can be combined, iterated or otherwise repeated, or performed in another manner.

At 510, a first message is transmitted from the central AP device 502 of the motion sensing system 506 to the cloud-based computer system 504. In some implementations, the first message includes motion sensing system data. The motion sensing system data of the first message includes device information, environment information for an environment of the motion sensing system 506, and information about the wireless communication network. In some instances, the motion sensing system data includes other information of the motion sensing system 506.

In some implementations, prior to the operation 510, a wireless communication topology of the wireless communication network is formed. In some instances, a user can plug in AP devices. As the AP devices boot up, the AP devices may communicate with one another. In some instances, when new STA devices are powered on, an association process may be performed between the new STA devices and neighboring AP devices. In some implementations, an association process is performed to associate STA devices to compatible AP devices within its proximity. Once the STA devices are successfully associated to the AP devices, data transfer as part of the wireless data communication may begin on respective wireless communication links between the STA devices and the associated AP devices.

In some implementations, the wireless communication links form a wireless communication topology of the wireless communication network, and the wireless communication topology can change over time (e.g., as devices enter and leave the network, etc.). A motion sensing topology can also be initiated, and may also change over time. In some instances, the motion sensing topology of a motion sensing system can be the same as the wireless communication topology, or the motion sensing topology can be different from the wireless communication topology. For instance, the two topologies can be independently controlled in some cases.

In some implementations, the performance of wireless communication devices for motion sensing in various environments can be used for guiding a reconfiguration of the motion sensing topology. For example, information from thousands or millions of wireless communication devices in a vast network of motion sensing systems can be collected by the cloud-based computer system. Health scores and other types of knowledge can be extracted from the information and used to improve the operation motion sensing systems. In some implementations, performances of wireless communication devices in different environments for motion sensing are evaluated by health score data. In some implementations, a motion sensing topology of a motion sensing system can be controlled, tuned, and otherwise modified based on health score data of wireless communication devices. In some implementations, the motion sensing system collects motion sensing system data, which is used by the cloud-based computer system 504 to determine the health score data.

In some implementations, device information of the motion sensing system data includes information for each of the wireless communication devices of the motion sensing system 506, and may also include an initial motion sensing topology. Device information of a wireless communication device can include, for example, a device type (e.g., smartphone, tablet, speaker, television, camera, thermostat, access point, printer, etc.), a manufacturer (e.g., Apple, Samsung, Microsoft, Google, etc.), a model (e.g., model number of a specific device), a version (e.g., software or hardware version), power source (e.g., whether the wireless communication devices operate on a battery), or other information of the wireless communication device. In some instances, the central AP device 502 may collect the device information by communicating with the associated STA devices and other AP devices in the motion sensing system 506. In certain instances, device information of an STA device may be communicated to an AP device during an association process or may be collected in another manner.

In some implementations, motion sensing system data also includes environment information for an environment of the motion sensing system 506. In some implementations, environment information includes a geographic location (e.g., country, state, city, street, etc.), a type of structure (e.g., steel, wood, concrete, number of floors, etc.), a type of insulation (e.g., foil radiation barrier, foam, etc.), a size of a space, a type of space (e.g., office, single-family house, apartment, multi-family house, etc.), and other environment information. In some instances, the environment information of the motion sensing system 506 can be input or uploaded by a user to the multi-AP controller (e.g., a software operated on the central AP device 502) or collected by the motion sensing system 506 in another manner. In some implementations, environment information includes locations of the wireless communication devices within the space (e.g., kitchen, garage, backyard, etc.). For example, time-of-flight (e.g., round trip time) may be used to measure relative position between the wireless communication devices (e.g., the STA devices and the associated AP devices) to construct a 3D map of device locations. In some instances, locations of the wireless communication devices may be specified by a user, or uploaded into the central AP device 502 in another manner.

In some implementations, the motion sensing system data further includes other information of the motion sensing system 302. For example, the motion sensing system data may further include a number of AP devices in the wireless communication network; a network type of the wireless communication network (e.g., multi-AP network; single-AP network; Wi-Fi network; Bluetooth network; etc.) or a type of wireless standard used by the wireless communication network (e.g., Wi-Fi Direct, the IEEE 802.11md standard, the IEEE 802.11az standard, the IEEE 802.11ax standard, and the IEEE 802.11be standard).

At 512, the cloud-based computer system 504 determines health score data of the wireless communication devices. In some implementations, health score data of the wireless communication devices are determined in response to the received motion sensing system data in the first message. Health score data of a wireless communication device of a motion sensing system characterize the overall performance of the wireless communication device in a particular environment where the motion sensing system resides. In some implementations, health score data of a wireless communication device include a health score with a value in a range of −1 to 1, or in another range. For example, a health score with a value of 1 for a wireless communication device indicates a high feasibility of the wireless communication device for motion sensing in the environment. On the other hand, a health score with a value of −1 for a wireless communication device indicates a poor feasibility of the wireless communication device for motion sensing in the environment.

In some implementations, health score data of wireless communication devices in a motion sensing system are determined by referring to the reference database stored in a memory device of the cloud-based computer system 504. The reference database includes reference devices and corresponding reference health scores in a variety of reference environments. In some implementations, reference health scores of wireless communication devices in various environments are pre-determined (e.g., according to an algorithm or in another manner). In some instances, a reference health score of a reference device in a reference environment can be determined by collecting and analyzing performance data from the reference environment.

In some instances, health score data of a wireless communication device are determined by finding the reference health score of the same wireless communication device in the same or similar environment. In certain instances, health score data of a wireless communication device are determined by computing an average value of the reference health scores in multiple reference environments. In this case, the health score data may also include a standard deviation. In some instances, a health score is determined based on two main contributors, including how well a wireless communication device in a motion-sensing network responds to channel sounding. If a sounding originator (e.g., an AP device) sends a first number of requests X₁ over a time interval T, the number of responses received from the wireless communication device in response to the X₁ requests can be used to determine the health score. In some instances, a health score is determined based on how many responses out of all received responses from the wireless communication device are being rejected, e.g., due to poor signal quality detected by a motion-sensing algorithm. After some of the responses are missed or rejected, a second number of responses X₂ over the same time interval T can be processed by the motion-sensing algorithm. In some instances, a health score S describes a relationship between the first and second numbers of responses X₁, X₂ (e.g., the ratio X₂/X₁, or another value may be used as the health score).

In certain instances, a health score value of a wireless communication device can be affected by factors such as the environment and the wireless communication device itself. Thus, the health score value can change over time. Changes in a health score value of a wireless communication device can be collected over time and stored on both the AP device and the cloud-based computer system, which can be used to determine how well a wireless communication device operates based on comparing the current health score value with a previously collected health score value from either the same wireless communication device or similar wireless communication devices of the similar type. In some implementations, the health score values collected over time can be analyzed to obtain statistical parameters (e.g., mean values, standard deviation, etc.), which can be included in the health score data.

In some instances, the health score data of a wireless communication device includes a predicted value based on reference health scores of the same wireless communication device in multiple reference environments according to a pre-determined algorithm. In some instances, health score data of a wireless communication device includes a predicted value based on reference health scores of multiple similar wireless communication devices in the same reference environment according to a pre-determined algorithm. In some instances, health score data of a wireless communication device can be determined in another manner. If a wireless communication device is not included in the reference database, health score data of the wireless communication device may include a health score set at a default value, e.g., 0.1 or another value. In some implementations, the operation 512 may be implemented as the example process 520 as described in FIG. 5B, or in another manner. In some instances, the reference database may be implemented as the reference database shown in FIGS. 6A-6B or in another manner.

FIGS. 6A-6B are tables 600, 610 showing aspects of a reference database that is used for determining health score data of wireless communication devices. Table 600 of a reference database shown fourteen entries including eleven wireless communication devices and their corresponding reference health scores in four different types of environments. Table 610 of the reference database shows four entries including environment information of the four types of environments in table 600. For example, when a wireless communication network includes a smart switch (device 5) and the wireless communication network resides in a type 1 environment, a health score of the smart switch is equal to the reference health score (H5). For another example, the reference database may include multiple entries of the same wireless communication device in the same type of environment or different types of environments. In this case, when a wireless communication network includes a speaker and the wireless communication network resides in a type 1 environment, a health score of the speaker in a type 1 environment may be equal to an average value of the reference health scores of the speaker in the same type of environment; and the health score data include a standard deviation of the reference health scores. For another example, when a wireless communication network includes a speaker and the wireless communication network resides in an environment that is not included in the reference database, a health score of the wireless communication device may be equal to an average value of the reference health scores in different environments in the reference database. The health score data can then be used to generate an overall health score that indicates how well a wireless communication devices operates as a wireless motion sensor. The health scores may inform how frequently to ping particular wireless communication devices, the signal strength used to ping devices, the requested power used for the response, and other parameters.

At 514, after determining the health score data for the wireless communication devices of the motion sensing system 506, a second message including the health score data is transmitted by the cloud-based computer system 504 to the central AP device 502 of the motion sensing system 506. In some implementations, health score data include health scores for all wireless communication devices in the motion sensing system; health scores for a subset of wireless communication devices in the motion sensing system; and a range of health scores for all or some of the wireless communication devices of the motion sensing system.

At 516, after receiving the second message, the central AP device 502 updates the motion sensing system 506 based on the received health score data of the wireless communication devices in the motion sensing system 506. In some implementations, the health score data of the wireless communication devices are used to set health scores for the wireless communication devices. In some implementations, the health scores of the health score data are used to update the motion sensing topology of the motion sensing system. In some cases, a subset of wireless communication devices (leaf nodes) of the motion sensing system can be selected for motion sensing according to the respective health scores in the health score data. For example, when a health score of a wireless communication device is less than a pre-determined threshold value, the wireless communication device can be removed from the motion sensing system or not selected for motion sensing. In some cases, the selection of wireless communication devices can be dynamic. For example, the motion sensing system may choose a higher or lower number of wireless communication devices based on the environment. In some implementations, the operation 516 may be implemented as the example process 530 as described in FIG. 5C, or in another manner.

In some implementations, one or more STA devices (e.g., “leaf” nodes) in a motion sensing system are selected during the operation 516 such that the one or more leaf nodes can be used for motion detection. For example, only a selected subset of wireless communication devices which have health scores higher than or equal to the threshold value is used for sending and receiving motion sensing signals. For another example, the motion sensing topology may remain unchanged. In this case, all the wireless communication devices in the motion sensing system are used for sending and receiving motion sensing signals, but only the data from the selected subset of wireless communication devices are used for motion sensing.

In some cases, the health score data can be combined with other data sources to see, e.g., how local environmental conditions affect readings, both in-house type conditions (e.g., building materials, location, internal temperature, style of house, etc.) and broader external environmental factors (e.g., external temperature, humidity, time of day, etc.). Also, certain decisions can be made by the cloud-based computer system, which may save CPU processing power on the motion sensing system, and may improve overall motion sensing performance.

After the motion sensing topology is updated, a series of motion sensing measurements can be executed on the wireless communication links. When the motion sensing measurement is performed, a set of observed channel responses are obtained based on a set of wireless signals transmitted through a space (or propagation environment). In some implementations, channel state information (CSI) for each of the wireless communication links may be processed to detect, for example, whether motion has occurred in the space, to determine a relative location of the detected motion, or both. In some aspects, the channel state information for each of the wireless communication links may be analyzed to detect whether an object is present or absent, e.g., when no motion is detected in the space.

In some implementations, the wireless sensing system can output motion data based on the channel state information. In some instances, the motion data indicates a degree of motion in the space, the location of motion in the space, a time at which the motion occurred, or a combination thereof. In some instances, the motion data can include a motion score, which may include, or may be, one or more of the following: a scalar quantity indicative of a level of signal perturbation in the environment accessed by the wireless signals; an indication of whether there is motion; an indication of whether there is an object present; or an indication or classification of a gesture performed in the environment accessed by the wireless signals.

In some instances, the motion sensing system data can be updated. For example, when firmware or software of a wireless communication device is upgraded, the motion sensing system data can be updated and transmitted to the cloud-based computer system 504 in order to obtain an updated health score data of the wireless communication device. For another example, when a new wireless communication device is added to the wireless communication network, the motion sensing system data can be updated and transmitted to the cloud-based computer system 504 to obtain a health score data of the newly added wireless communication device. In certain instances, the motion sensing system data may be periodically transmitted, transmitted irregularly, transmitted on a predetermined schedule, triggered by another event, or in another manner. For example, a motion sensing system can be switched between different modes (e.g., from “HOME” mode to “AWAY” mode). In this case, since performance requirements for the motion sensing system under different modes may be different (e.g., different security zones, different sensitivity thresholds, etc.), configurations of wireless communication devices may be changed (e.g., packet rate, frequency, and channel bandwidth). The motion sensing system data can be updated and transmitted to the cloud-based computer system 504 to determine health score data of wireless communication devices so as to tune the motion sensing topology to optimize or otherwise improve the motion sensing performance under different modes.

In some instances, the motion sensing system data may be transmitted by the motion sensing system 506, when the motion sensing system 506 is notified by the cloud-based computer system 504 that the reference database has been updated. In some instances, the reference database on the cloud-based computer system 504 may be periodically updated, updated on a predetermined schedule, or in another manner. For example, an update to the reference database includes an update to a reference health score of an existing wireless communication device, a new entry of a new wireless communication device in an existing environment, a new entry of an existing wireless communication device in a new environment, or an update to the algorithm for determining a health score data based on similar devices in similar environments. In certain instances, the reference database may be updated in another manner.

FIG. 5B is a flow chart showing aspects of an example process 520 for determining health score data of wireless communication devices in a motion sensing system. In some implementations, the example process 520 is performed by operation of a cloud-based computer system 504. In some examples, health score data of wireless communication devices of the motion sensing system can be determined based on motion sensing system data. In some instances, the motion sensing system includes wireless communication devices communicating with one another to form a wireless communication network. In some instances, the motion sensing system may be implemented as the motion sensing system 302 in FIG. 3B, the motion sensing system 506 in FIG. 5A, or in another manner. The example process 520 as shown in FIG. 5B may include additional or different operations, including operations performed by additional or different components, and the operations may be performed in the order shown or in another order. In some cases, operations in the example process 520 as shown in FIG. 5B can be combined, iterated or otherwise repeated, or performed in another manner.

At 522, a reference environment is identified. In some implementations, the reference environment is identified by the cloud-based computer system 504, according to the motion sensing system data received in a message (e.g., the first message during operation 512 in FIG. 5A). For example, device information, environment information, information about the wireless communication network as part of the motion sensing system data are compared with entries in a reference database stored on the cloud-based computer system 504. In some cases, a reference environment that matches the motion sensing system data can be identified. In some instances, when there is no exact match of the environment, a default environment may be selected.

At 524, health score statistics are identified. In some implementations, the health score statistics for the wireless communication device are identified for the reference environment based on the device information. In some implementations, the health score statistics include an average health score and a standard deviation for each wireless communication device. In certain instances, an average health score and a standard deviation are computed based on values of the reference health scores in multiple reference environments. In some instances, health score statistics may have a predicted health score value and a confidence interval based on reference health scores of the same wireless communication device in multiple reference environments according to a pre-determined algorithm; based on reference health scores of multiple similar wireless communication devices in the same reference environment according to a pre-determined algorithm; or determined in another manner. If a wireless communication device is not included in the reference database, health score statistics may include a health score set at a default value, e.g., 0.1 or another value.

At 526, health score data are determined based on the health score statistics. In this case, the health score data for each wireless communication device is based on the average health score and the standard deviation. In some implementations, health score data include health score statistics for all wireless communication devices in the motion sensing system; or health score statistics for a subset of wireless communication devices in the motion sensing system,

FIG. 5C is a flow chart showing aspects of an example process 530 for determining, controlling, modifying, or reconfiguring the motion sensing topology of the motion sensing system 502. In some implementations, the example process 530 is performed by operation of a motion sensing system. In some instances, the example process 530 may be performed by an AP device of the motion sensing system (e.g., when the motion sensing system is based on a multi-AP wireless communication network). In some instances, the AP device for performing the example process 530 is a central AP device of the motion sensing system, an AP device with a multi-AP controller, an AP device with a wired internet connection, or another wireless communication device of the motion sensing system. The example process 530 as shown in FIG. 5C may include additional or different operations, including operations performed by additional or different components, and the operations may be performed in the order shown or in another order. In some cases, operations in the example process 530 as shown in FIG. 5C can be combined, iterated or otherwise repeated, or performed in another manner.

At 532, health scores are set. In some implementations, the health scores for the wireless communication devices of the motion sensing system are set according to the health score data received from the cloud-based computer system. In some cases, an initial health score can be set for a wireless communication device according to the health score data. In some instances, health scores for the wireless communication devices can be updated based on quality testing of the wireless communication device. In some instances, wireless communication devices can be tested (e.g., in a controlled environment of a testing facility or in a customer's local environment), such that the performance of wireless communication devices are tested and collected over an extended time period. The testing can include, for example sending a number of sounding requests to a wireless communication device over a time period, and determining a number of responses from the wireless communication device that can be used for motion-sensing. In certain instances, health scores for the wireless communication devices can be updated based the quality testing results. For example, a health score can be updated based on the number of requests and the number of successful responses (e.g., the ratio of the values), or the health score may be updated based on quality testing in another manner. In some instances, when a health score of a wireless communication device shows a significant deviation from the health score data received from the cloud-based computer system, this may indicate a problematic environment or faulty device that requires a replacement or an exclusion from the motion sensing system.

At 534, a subset of wireless communication devices are selected. In some implementations, the subset of wireless communication devices are selected based on the health score data. For example, the subset of wireless communication devices that have health scores above a predetermined threshold (e.g., greater than 0 or another threshold value) can be selected. For another example, a specified number (or percentage) of wireless communication devices that have the highest health scores can be selected. In some implementations, health score data are used to determine parameters of motion sensing measurement, for example, frequencies for pinging the selected subset of wireless communication devices during motion sensing measurement, levels of signal strength for pinging the selected subset of wireless communication devices, requested power levels used for the response, and other parameters.

At 536, the motion sensing system is configured. In some implementations, the motion sensing system is configured or reconfigured to use the selected subset of wireless communication devices (e.g., STA devices or leaf nodes) for motion sensing based on data and intelligence provided by the cloud-based computer system. In other words, the motion sensing topology of the motion sensing system is updated by including only the selected subset of wireless communication devices and associated wireless communication links.

In some implementations, the central AP device 504 sends the update to the extended AP devices. In some instances, the central AP device 504 may explicitly instruct the extended AP devices to include certain STA devices for motion sensing. In some instances, the central AP device 504 may also specify a schedule of motion sensing measurements on respective wireless communication links to the extended AP devices. In some instances, the central AP device 504 also specifies a type of motion sensing measurement for the respective wireless communication links.

In some instances, when a motion sensing measurement is performed, the motion sensing measurement can be initialized by the multi-AP controller and can be performed by the respective AP devices and STA devices according to the motion sensing topology and the scheduled motion sensing measurements. In some implementations, a motion sensing measurement can be performed on the at least one wireless communication link.

In this case, the updated motion sensing topology, which is different from the wireless communication topology, is formed within the wireless communication network. In some implementations, the motion sensing topology and the wireless communication topology can operate independently, together, or otherwise in a controlled manner, allowing for optimized performance in wireless data communication and motion sensing. In some implementations, the motion sensing topology includes a subset of wireless communication devices and a subset of wireless communication links from the wireless communication topology.

Some of the subject matter and operations described in this specification can be implemented in digital electronic circuitry, or in computer software, firmware, or hardware, including the structures disclosed in this specification and their structural equivalents, or in combinations of one or more of them. Some of the subject matter described in this specification can be implemented as one or more computer programs, i.e., one or more modules of computer program instructions, encoded on a computer storage medium for execution by, or to control the operation of, data-processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

Some of the operations described in this specification can be implemented as operations performed by a data processing apparatus on data stored on one or more computer-readable storage devices or received from other sources. The term “data-processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some of the processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

To provide for interaction with a user, operations can be implemented on a computer having a display device (e.g., a monitor, or another type of display device) for displaying information to the user and a keyboard and a pointing device (e.g., a mouse, a trackball, a tablet, a touch sensitive screen, or another type of pointing device) by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

In a general aspect, a motion sensing system based is configured to operate in an environment.

In a first example, device information for a plurality of wireless communication devices available for use in a motion sensing system is obtained. Motion sensing system data is sent from the motion sensing system to a cloud-based computer system. The motion sensing system data includes the device information and environment information. In response to the motion sensing system data, health score data for the plurality of wireless communication devices are received from the cloud-based computer system. Health scores for the plurality of wireless communication devices are configured according to the health score data. Based on the health scores, a subset of the plurality of wireless communication devices are selected to use for motion detection. The motion sensing system is updated to use the selected subset of wireless communication devices for motion detection.

Implementations of the first example may include one or more of the following features. The device information for each wireless communication device includes at least one of a device type of the wireless communication device, a manufacturer of the wireless communication device, a model of the wireless communication device, or a version of the wireless communication device. The environment information includes at least one of a geographic location of the motion sensing system, a type of structure where the motion sensing system resides, or a size of a space where the motion sensing system resides. The plurality of wireless communication devices communicate in a wireless communication network. The motion sensing system data further includes a number of mesh access point devices in the wireless communication network; a network type of the wireless communication network; or a type of wireless protocol used by the wireless communication network. When the health scores for the plurality of wireless communication devices are configured according to the health score data, an initial health score parameter for a first wireless communication device is configured. The health score for the first wireless communication devices is updated based on quality testing of the first wireless communication device.

In a second example, a system includes a cloud-based computer system including one or more processors; and a motion sensing system including a plurality of wireless communication devices. The plurality of wireless communication devices includes an access point communicably coupled to the cloud-based computer system. The access point is configured to perform one or more operations of the first example.

In a third example, at a cloud-based computer system, motion sensing system data is received from a motion sensing system. The motion sensing system data includes device information for a plurality of wireless communication devices available for use in the motion sensing system, and environment information for an environment of the motion sensing system. By operation of one or more processors of the cloud-based computer system, a reference environment is identified based on the environment information. Based on the device information, health score statistics for the wireless communication devices are identified for the reference environment. Health score data are determined for the plurality of wireless communication devices based on the health score statistics. The health score data for the plurality of wireless communication devices are sent to the motion sensing system. The health score data are provided by the cloud-based computer system in response to the motion sensing system data.

Implementations of the third example may include one or more of the following features. The health score statistics include an average health score and a standard deviation for each wireless communication device, and the health score data for each wireless communication device is based on the average health score and the standard deviation. The device information includes, for each wireless communication device, at least one of a device type of the wireless communication device; a manufacturer of the wireless communication device; a model of the wireless communication device; or a version of the wireless communication device. The environment information includes at least one of a geographic location of the motion sensing system; a type of structure where the motion sensing system resides; or a size of a space where the motion sensing system resides. The plurality of wireless communication devices communicate in a wireless communication network, and the motion sensing system data further includes a number of mesh access point devices in the wireless communication network; a network type of the wireless communication network; or a type of wireless protocol used by the wireless communication network.

In a fourth example, a system includes a motion sensing system and a cloud-based computer system. The motion sensing system includes a plurality of wireless communication devices, and the plurality of wireless communication devices includes an access point. The cloud-based computer system includes one or more processors. The cloud-based computer system is communicably coupled to the motion sensing system and configured to perform operations of the fourth example.

While this specification contains many details, these should not be understood as limitations on the scope of what may be claimed, but rather as descriptions of features specific to particular examples. Certain features that are described in this specification or shown in the drawings in the context of separate implementations can also be combined. Conversely, various features that are described or shown in the context of a single implementation can also be implemented in multiple embodiments separately or in any suitable sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single product or packaged into multiple products.

A number of embodiments have been described. Nevertheless, it will be understood that various modifications can be made. Accordingly, other embodiments are within the scope of the description above.

1. A method comprising:
obtaining device information for a plurality of wireless communication devices available for use in a motion sensing system;
sending motion sensing system data from the motion sensing system to a cloud-based computer system, the motion sensing system data comprising:
the device information for the plurality of wireless communication devices; and
environment information for an environment of the motion sensing system;
receiving, from the cloud-based computer system, health score data for the plurality of wireless communication devices, wherein the health score data are provided by the cloud-based computer system in response to the motion sensing system data;
in the motion sensing system, determining health scores for the plurality of wireless communication devices based on the health score data from the cloud-based computer system;
based on the health scores, selecting a subset of the plurality of wireless communication devices to use for motion detection in the motion sensing system; and
updating the motion sensing system to use the selected subset of wireless communication devices for motion detection.

2. The method of claim 1, wherein the device information comprises, for each wireless communication device, at least one of:
a device type of the wireless communication device;
a manufacturer of the wireless communication device;
a model of the wireless communication device; or
a version of the wireless communication device.

3. The method of claim 1, wherein the environment information comprises at least one of:
a geographic location of the motion sensing system;
a type of structure where the motion sensing system resides; or
a size of a space where the motion sensing system resides.

4. The method of claim 1, wherein the plurality of wireless communication devices communicate in a wireless communication network, and the motion sensing system data further comprises:
a number of mesh access point devices in the wireless communication network;
a network type of the wireless communication network; or
a type of wireless protocol used by the wireless communication network.

5. The method of claim 1, wherein determining the health scores for the plurality of wireless communication devices based on the health score data comprises setting an initial health score for a first wireless communication device equal to a health score value provided in the health score data, and the method comprises updating the health score for the first wireless communication devices based on quality testing of the first wireless communication device.

6. A motion sensing system comprising a plurality of wireless communication devices, the plurality of wireless communication devices comprising an access point communicably coupled to a cloud-based computer system and configured to perform operations comprising:
sending motion sensing system data to the cloud-based computer system, the motion sensing system data comprising:
the device information for the plurality of wireless communication devices; and
environment information for an environment of the motion sensing system;
receiving, from the cloud-based computer system, health score data for the plurality of wireless communication devices, wherein the health score data are provided by the cloud-based computer system in response to the motion sensing system data;
configuring health scores for the plurality of wireless communication devices according to the health score data from the cloud-based computer system;
based on the health scores, selecting a subset of the plurality of wireless communication devices to use for motion detection in the motion sensing system; and
updating the motion sensing system to use the selected subset of wireless communication devices for motion detection.

7. The motion sensing system of claim 6, wherein the device information comprises, for each wireless communication device, at least one of:
a device type of the wireless communication device;
a manufacturer of the wireless communication device;
a model of the wireless communication device; or
a version of the wireless communication device.

8. The motion sensing system of claim 6, wherein the environment information comprises at least one of:
a geographic location of the motion sensing system;
a type of structure where the motion sensing system resides; or
a size of a space where the motion sensing system resides.

9. The motion sensing system of claim 6, wherein the plurality of wireless communication devices communicate in a wireless communication network, and the motion sensing system data further comprises:
a number of mesh access point devices in the wireless communication network;
a network type of the wireless communication network; or
a type of wireless protocol used by the wireless communication network.

10. The motion sensing system of claim 6, wherein determining the health scores for the plurality of wireless communication devices based on the health score data comprises setting an initial health score for a first wireless communication device equal to a health score value provided in the health score data, and the method comprises updating the health score for the first wireless communication devices based on quality testing of the first wireless communication device.

11. A method comprising:
at a cloud-based computer system, receiving motion sensing system data from a motion sensing system, the motion sensing system data comprising:
device information for a plurality of wireless communication devices available for use in the motion sensing system; and
environment information for an environment of the motion sensing system;
by operation of one or more processors of the cloud-based computer system:
identifying a reference environment based on the environment information;
based on the device information, identifying health score statistics for the wireless communication devices for the reference environment; and
determining health scores for the plurality of wireless communication devices based on the health score statistics; and
sending, from the cloud-based computer system to the motion sensing system, the health score data for the plurality of wireless communication devices, wherein the health score data are provided by the cloud-based computer system in response to the motion sensing system data.

12. The method of claim 11, wherein the health score statistics comprise an average health score and a standard deviation for each wireless communication device, and the health score for each wireless communication device is based on the average health score and the standard deviation.

13. The method of claim 11, wherein the device information comprises, for each wireless communication device, at least one of:
a device type of the wireless communication device;
a manufacturer of the wireless communication device;
a model of the wireless communication device; or
a version of the wireless communication device.

14. The method of claim 11, wherein the environment information comprises at least one of:
a geographic location of the motion sensing system;
a type of structure where the motion sensing system resides; or
a size of a space where the motion sensing system resides.

15. The method of claim 11, wherein the plurality of wireless communication devices communicate in a wireless communication network, and the motion sensing system data further comprises:
a number of mesh access point devices in the wireless communication network;
a network type of the wireless communication network; or
a type of wireless protocol used by the wireless communication network.

16. A cloud-based computer system comprising:
one or more processors; and
memory storing instructions that, when executed by the one or more processors, perform operations comprising:
receiving motion sensing system data from a motion sensing system, the motion sensing system comprising a plurality of wireless communication devices, the plurality of wireless communication devices comprising an access point, the motion sensing system data comprising:
device information for the plurality of wireless communication devices; and
environment information for an environment of the motion sensing system;
identifying a reference environment based on the environment information;
based on the device information, identifying health score statistics for the wireless communication devices for the reference environment; and
determining health scores for the plurality of wireless communication devices based on the health score statistics; and
sending the health scores for the plurality of wireless communication devices to the motion sensing system, wherein the health scores are provided by the cloud-based computer system in response to the motion sensing system data.

17. The cloud-based computer system of claim 16, wherein the health score statistics comprise an average health score and a standard deviation for each wireless communication device, and the health score for each wireless communication device is based on the average health score and the standard deviation.

18. The cloud-based computer system of claim 16, wherein the device information comprises, for each wireless communication device, at least one of:
a device type of the wireless communication device;
a manufacturer of the wireless communication device;
a model of the wireless communication device; or
a version of the wireless communication device.

19. The cloud-based computer system of claim 16, wherein the environment information comprises at least one of:
a geographic location of the motion sensing system;
a type of structure where the motion sensing system resides; or
a size of a space where the motion sensing system resides.

20. The cloud-based computer system of claim 16, wherein the plurality of wireless communication devices communicate in a wireless communication network, and the motion sensing system data further comprises:
a number of mesh access point devices in the wireless communication network;
a network type of the wireless communication network; or
a type of wireless protocol used by the wireless communication network.
